(19) United States
(12) Patent Application Publication
(10) Pub. No.: US 2013/0254073 A1
(43) Pub. Date: Sep. 26, 2013

(54) SYSTEM AND METHOD FOR RETURNING INDIVIDUAL LINES OF A PURCHASE REQUISITION FOR CORRECTION AND APPROVAL

(71) Applicants: Mayukh Bhaowal, Redwood City, CA (US); Angela Xian, Cupertino, CA (US); Shibhu Nambiar, Springfield, VA (US); Lee Quek, Foster City, CA (US); Suman Guha, Fremont, CA (US)

(72) Inventors: Mayukh Bhaowal, Redwood City, CA (US); Angela Xian, Cupertino, CA (US); Shibhu Nambiar, Springfield, VA (US); Lee Quek, Foster City, CA (US); Suman Guha, Fremont, CA (US)

(73) Assignee: Oracle International Corporation, Redwood Shores, CA (US)

(21) Appl. No.: 13/428,409

(22) Filed: Mar. 23, 2012

(51) Int. Cl. G06Q 10/08; G06Q 30/00

(52) U.S. Cl. 705/26.82

(57) ABSTRACT

Embodiments of the present invention relate generally to methods and systems for processing purchase requisitions and purchase orders in a procurement system and more particularly systems and methods for returning single or individual requisition lines back to the requester without affecting other associated requisition lines under the same requisition. Generally speaking, embodiments allow users of a procurement system to return individual requisition lines instead of returning all the requisition lines in the purchase requisition. In some cases, policies require all or some subset of all lines of a requisition be processed together when possible. Hence, if there are more than one requisition lines, the buyer can be presented with a choice whether he or she would like to return the individual line or whether he would like to return all or some subset of all of the lines allowing a buyer to make a more informed decision.

### BACKGROUND OF THE INVENTION

Embodiments of the present invention relate generally to methods and systems for processing purchase requisitions and purchase orders in a procurement system and more particularly to returning single or individual requisition lines back to the requester without affecting other associated requisition lines under the same requisition.

Purchase requisitions are formal requests created by internal organizations and sent to the purchasing department to procure goods or services. A requisition consists of one or more requisition lines. Typically a requisition line contains details such as a description, quantity of the goods or services to be purchased, preferred make, a desired delivery date, cost center and the amount of money that the purchasing department is authorized to spend for the goods or services. In current procurement systems, a purchase requisition is comprised of multiple requisition lines, each representing a line of request. Such requisitions, typically created by requesters or requisition preparers can have incorrect or outdated data and may need corrections, even though they have been approved by the requesting organization. For example, the purchase price may exceed the requisition price, or the buyer may know that the requested item is no longer being purchased.

Professional buyers in the purchasing department are responsible for reviewing the requisitions and identifying inaccuracies before they can process them into a legally binding obligation known as a purchase order. These purchase orders are contractually binding documents between the buying organization and a selling organization. In the conventional business process, buyers handle such inaccuracies by “returning” the requisitions back to the requester so that appropriate corrections can be made. However, returning a requisition based on a single requisition line results in returning all other requisition lines under the same purchase requisition which are not currently on a purchase order. As a consequence, the buyer has to wait until the specific line is corrected by the requester and the purchase requisition is subsequently reapproved.

Also, the interested organizations might have a financial impact if they have incorporated budgetary control and encumbrance accounting into their business process. This is typically true for federal, public sector and quasi-public sector organizations. In such organizations, the amount on the requisition is treated as a commitment or pre-encumbrance, and funds are adequately reserved for them. When a single requisition line is returned, the commitment is liquidated. Subsequently, if a problem with a single line results in the return of all other lines under the same requisition, that commitment associated with the other lines will also be liquidated. Although it is acceptable to liquidate the funds on the problematic requisition line, it is not acceptable to liquidate funds on the other correct requisition lines. In an encumbrance and budgetary control environment where funds are limited, losing funds which were already reserved has consequences. By the time the requisition line is corrected, other transactions can use up the funds, and the requisition might not be able to pass budgetary control any more. Hence, there is a need for improved methods and systems for processing returned requisition lines.

### BRIEF SUMMARY OF THE INVENTION

Embodiments of the invention provide systems and methods for processing purchase requisitions and purchase orders in a procurement system and more particularly allowing returning of single or individual requisition lines without impacting the other requisition lines for the same requisition. According to one embodiment, a method of processing a purchase requisition in a procurement system can comprise receiving from a requestor a first requisition comprising a plurality of requisition lines. The first requisition can be submitted for approval and funds of a budget can be reserved for each of the plurality of requisition lines of the first requisition. During approval, a determination can be made to return at least one line of the plurality of lines of the first requisition prior to approval of the first requisition. For example, determining to return the at least one line of the plurality of lines of the first requisition can further comprise identifying one or more lines of the first requisition related to the returned at least one line. The reserved funds for the returned at least one line of the first requisition can be liquidated without affecting the reserved funds for the plurality of requisition lines other than the returned at least one line.

The returned at least one line of the first requisition and any lines related to the returned at least one line of the first requisition can be presented to the requestor. In some cases, the related lines, if any, can be presented in a read-only mode. An update of the returned at least one line of the first requisition can be received and funds of the budget for the returned at least one line of the first requisition can be reserved based on the update of the returned at least one line of the first requisition. The update of the returned at least one line of the first requisition can then be re-submitted for approval.

According to another embodiment, a system can comprise a processor and a memory coupled with and readable by the processor. The memory can have stored therein a sequence of instructions which, when executed by the processor, cause the processor to process a purchase requisition by receiving from a requestor a first requisition comprising a plurality of requisition lines. The first requisition can be submitted for approval and funds of a budget can be reserved for each of the plurality of requisition lines of the first requisition. After initial approval, a determination can be made to return at least one line of the plurality of lines of the first requisition. For example, determining to return the at least one line of the plurality of lines of the first requisition can further comprise identifying one or more lines of the first requisition related to the returned at least one line. The reserved funds for the returned at least one line of the first requisition can be liquidated without affecting the reserved funds for the plurality of requisition lines other than the returned at least one line. The returned at least one line of the first requisition and any lines related to the returned at least one line of the first requisition can be presented to the requestor. In some cases, the related lines, if any, can be presented in a read-only mode. An update of the returned at least one line of the first requisition can be received and funds of the budget for the returned at least one line of the first requisition can be reserved based on the update of the returned at least one line of the first requisition. The update of the returned at least one line of the first requisition can then be re-submitted for approval.

According to yet another embodiment, a computer-readable memory can have stored thereon a sequence of instructions which, when executed by a processor, causes the processor to process a purchase requisition by receiving from a requestor a first requisition comprising a plurality of requisition lines. The first requisition can be submitted for approval and funds of a budget can be reserved for each of the plurality of requisition lines of the first requisition. After initial approval, a determination can be made to return at least one line of the plurality of lines of the first requisition. For example, determining to return the at least one line of the plurality of lines of the first requisition can further comprise identifying one or more lines of the first requisition related to the returned at least one line. The reserved funds for the returned at least one line of the first requisition can be liquidated without affecting the reserved funds for the plurality of requisition lines other than the returned at least one line. The returned at least one line of the first requisition and any lines related to the returned at least one line of the first requisition can be presented to the requestor. In some cases, the related lines, if any, can be presented in a read-only mode. An update of the returned at least one line of the first requisition can be received and funds of the budget for the returned at least one line of the first requisition can be reserved based on the update of the returned at least one line of the first requisition. The update of the returned at least one line of the first requisition can then be re-submitted for approval.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating, at a high-level, functional components of a system for processing individually returned requisition lines of a purchase requisition according to one embodiment of the present invention.

FIG. 4 is a flowchart illustrating a process for processing individually returned requisition lines of a purchase requisition according to one embodiment of the present invention.

FIG. 5 is a flowchart illustrating additional details of a process for processing individually returned requisition lines of a purchase requisition according to an embodiment of the present invention.

FIG. 6 is a flowchart illustrating a method for processing individually returned requisition lines of a purchase requisition according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the present invention relate generally to methods and systems for processing purchase requisitions and purchase orders in a procurement system and more particularly systems and methods for returning single or individual requisition lines back to the requester without affecting other associated requisition lines under the same requisition. Generally speaking, embodiments described herein allow professional buyers and/or other users of a procurement system to return “individual” requisition lines instead of being forced to return all the requisition lines belonging to the same purchase requisition. In some cases, there are businesses with policies that require all or some subset of all lines of a requisition be processed together when possible. Hence, according to some embodiments, if there are more than one requisition lines, the buyer can be presented with a choice whether he or she would like to return the individual line or whether he would like to return all or some subset of all of the lines allowing a buyer to make a more informed decision.

The requester can then edit and correct the returned, inaccurate requisition lines. Additionally, according to one embodiment, requester can be given a view-only access to other requisition lines, i.e., all of the other requisition lines or some subset of all of the other requisition lines. This view can provide additional and possibly related information to the requester for correcting the returned requisition line while preventing any edits or modifications to the other requisition lines which have not been returned. The requester can then submit the changes, and the requisition can go through a re-approval mechanism such that the approvers and the managers of the requesting organization have visibility to the changes.

For organizations operating under budgetary control and/or encumbrance accounting compliance procedures, the funds on the requisition line actually being returned can be liquidated. The funds reserved for the other requisition lines under the same requisition header can continue to stay reserved as a commitment. Various additional details of embodiments of the present invention will be described below with reference to the figures.

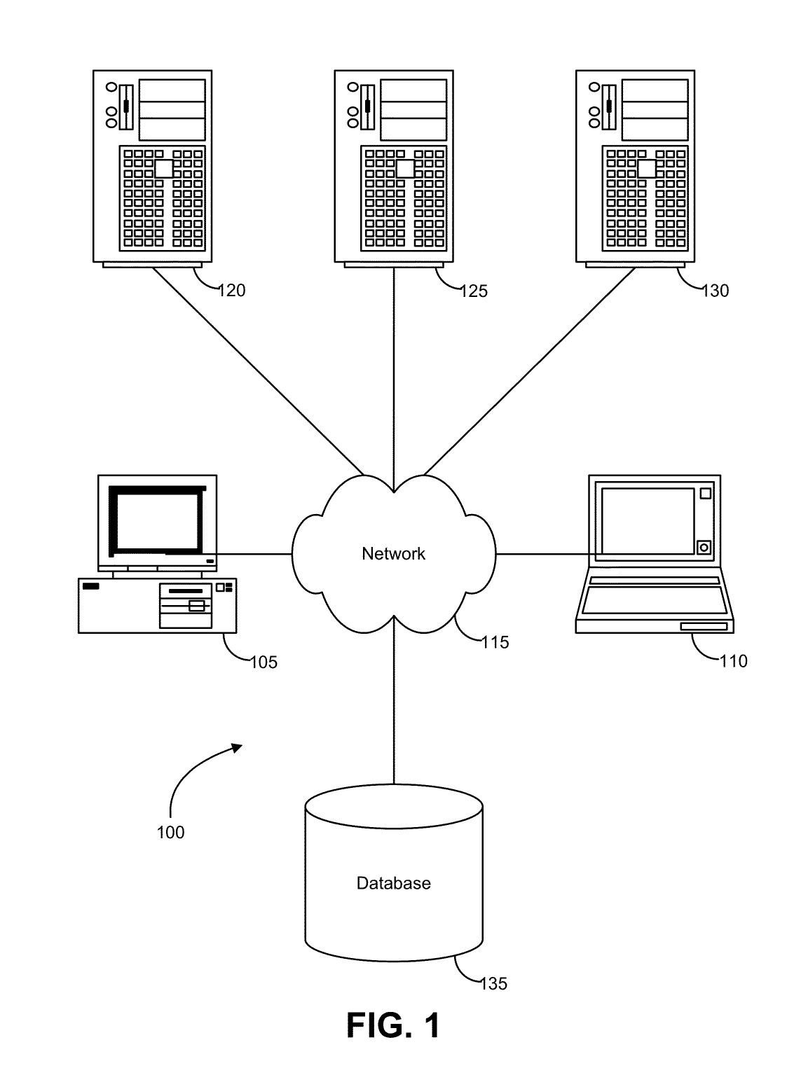

FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network can be any type of network familiar to those skilled in the art that can support data communications using any of a variety of commercially-available protocols, including without limitation TCP/IP, SNA, IPX, AppleTalk, and the like. Merely by way of example, the network 115 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, that is adapted to store, update, and retrieve data in response to SQL-formatted commands.

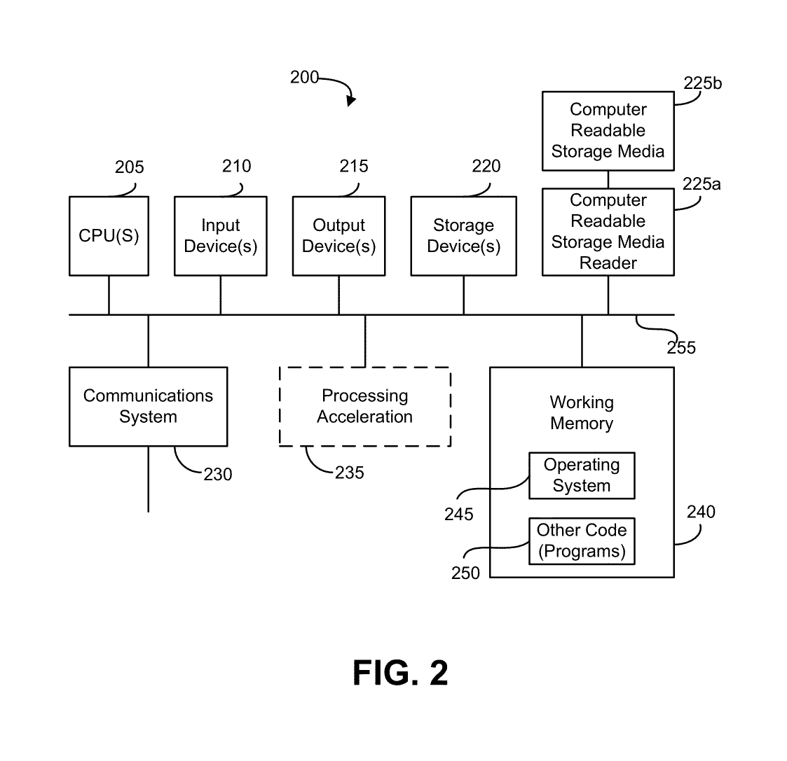

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

As noted above, embodiments of the present invention relate generally to methods and systems for processing purchase requisitions and purchase orders in a procurement system and more particularly to returning individual requisition lines without affecting other associated requisitions. Generally speaking, embodiments described herein allow professional buyers and/or other users of a procurement system to return “individual” requisition lines instead of being forced to return all the requisition lines belonging to the same purchase requisition. In some cases, there are businesses with policies that require all or some subset of all lines of a requisition be processed together when possible. Hence, according to some embodiments, if there are more than one requisition lines, the buyer can be presented with a choice whether he or she would like to return the individual line or whether he would like to return all or some subset of all of the lines allowing a buyer to make a more informed decision.

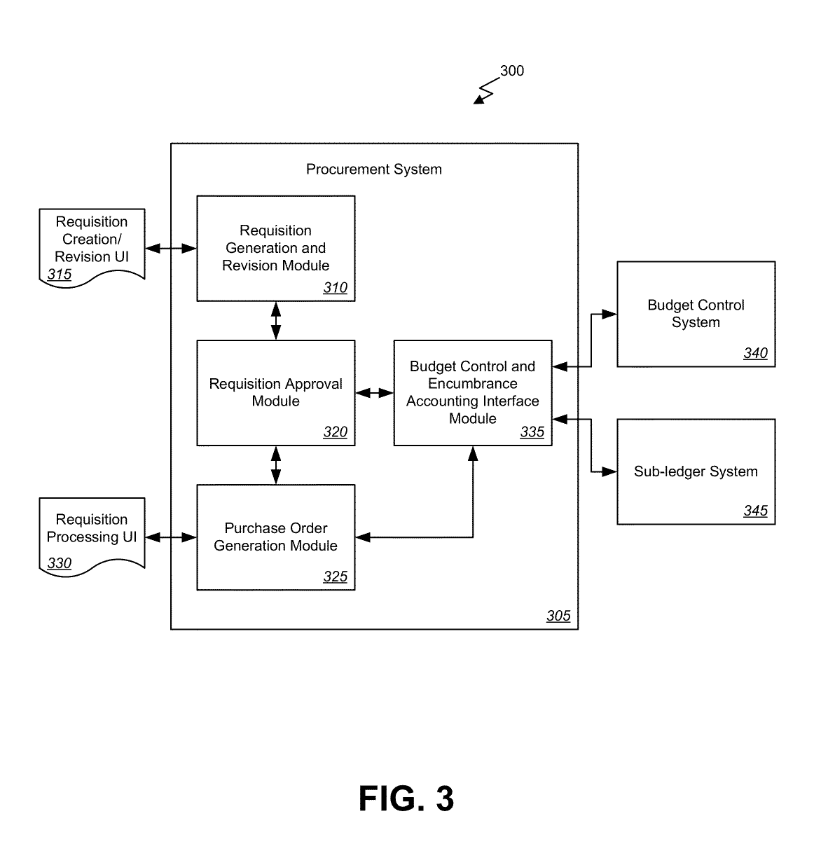

FIG. 3 is a block diagram illustrating, at a high-level, functional components of a system for processing individually returned requisition lines of a purchase requisition according to one embodiment of the present invention. In this example, the system 300 includes a procurement system 305, a budget control system 340, and/or a sub-ledger system 345 which can comprise any one or more of the computer systems described above executing procurement and accounting applications. The procurement system 305 can include a requisition generation and revision module 310. The requisition generation and revision module 310 can provide an interface 315 through which a requisition can be generated and submitted by a requestor.

As is common, the procurement system 305 can also include a requisition approval module 320, a budget control and encumbrance accounting interface module 335, and a purchase order generation module 325. Generally speaking, the budget control and encumbrance accounting interface module 335 can communicate and interact with the budget control system 340 and/or the sub-ledger system 345 to provide for accounting of budget amounts by the budget control system 340 and/or the sub-ledger system 345 based on requisitions submitted through the requisition creation user interface 315 and requisition generation and revision module 310 and approved by the requisition approval module 320. For example, the budget control and encumbrance accounting interface module 335 can request the budget control system 340 and/or sub-ledger system 345 to reserve funds for the requisition. Additionally, purchase orders can be generated by the purchase order generation module 325 based on the submitted requisitions approved through the requisition approval module 320. For example, the purchase order generation module 325 can generate and provide a requisition processing interface 330 through which a buyer can view and generate purchase orders from requisitions or return requisitions.

According to one embodiment, purchase order generation module 325 can present, through the requisition processing user interface 330, a choice to the buyer when a requisition is presented by the requisition approval module 325. The choice can allow the buyer to return the whole requisition, a single line of the requisition, or some subset of all of the requisition. Additionally, the requisition creation/revision user interface 315 can allow the requesters to identify other lines of the requisition which, while not necessarily being returned, are related or relevant to the line(s) being returned. Additionally or alternatively, such related or relevant lines can be identified by the requisition approval module 320, for example based on metadata, rules, and/or other information defining relationships and/or dependencies for individual requisition lines. For example, in some cases there may be approval rules at the requisition header level. For instance, such a rule may indicate that the total requisition amount should stay under $1000. In that case, the requisition approval module 320 can summarize the requisition line amount across other requisition lines to determine any additional approvers.

Once one or more returned lines have been identified, the budgetary control and encumbrance accounting interface module 335 of the procurement system 305 can request the budget control system 340 and/or the sub-ledger system 345 to liquidate funds on the specific returned requisition line(s). Additionally, the requisition generation and revision module 310 can update the requisition creation and revision user interface 315 to present the returned lines and any related or relevant other lines to the requestor for corrections or adjustments. According to one embodiment, the requisition creation and revision user interface 315 can allow edits to the returned requisition lines while presenting a view-only interface for the other, related or relevant requisition lines. After the buyer makes adjustments or corrections to the returned lines, those requisition lines can be resubmitted to the requisition approval module 320 for re-approval.

According to one embodiment, the procurement system 305 can also be adapted to manage complications due to subsequent return of requisition lines when there are already requisition lines returned and the latter are in the approval queue of the requesting organization or are being edited by the requester. For instance, assume a requisition has 5 requisition lines of which one has been returned back to the requester. The requester can correct it through the requisition creation and revision user interface 315 and resubmit it through the requisition generation and revision module 310 for re-approval by the requisition approval module 320. While in an approval queue of the requisition approval module 320, the system can keep track of it and prevent any of the other 4 requisition lines from being returned. Otherwise, a complex situation may arise where two requisition lines belonging to the same requisition will be in parallel approval queues.

Therefore, embodiments of the present invention provide for the preservation of funds reserved for the compliant requisition lines when the otherwise non-compliant requisition line is returned back to the requester by the buyer. This can be particularly important for budgetary controlled and encumbrance accounted organizations. Various embodiments also allow the compliant requisition lines to be sourced into purchase orders without any delay and thereby improve organizational and operational efficiency by saving valuable time. In addition, for requesters, where it is important to group requisition lines into the same purchase order, embodiments provide a “choice” of being able to return only the inaccurate line or all of the requisition lines. In addition, this allows the requester to decide whether it is still appropriate to order the rest of the requisition as is. If an individual requisition line had been returned, and the same requisition line is being edited by the requester or being routed through re-approval, subsequent return of requisition lines is prevented. Thus, various embodiments simplify or reduce possible complications in the business process where different parts of the document are at different stages of the requisition lifecycle.

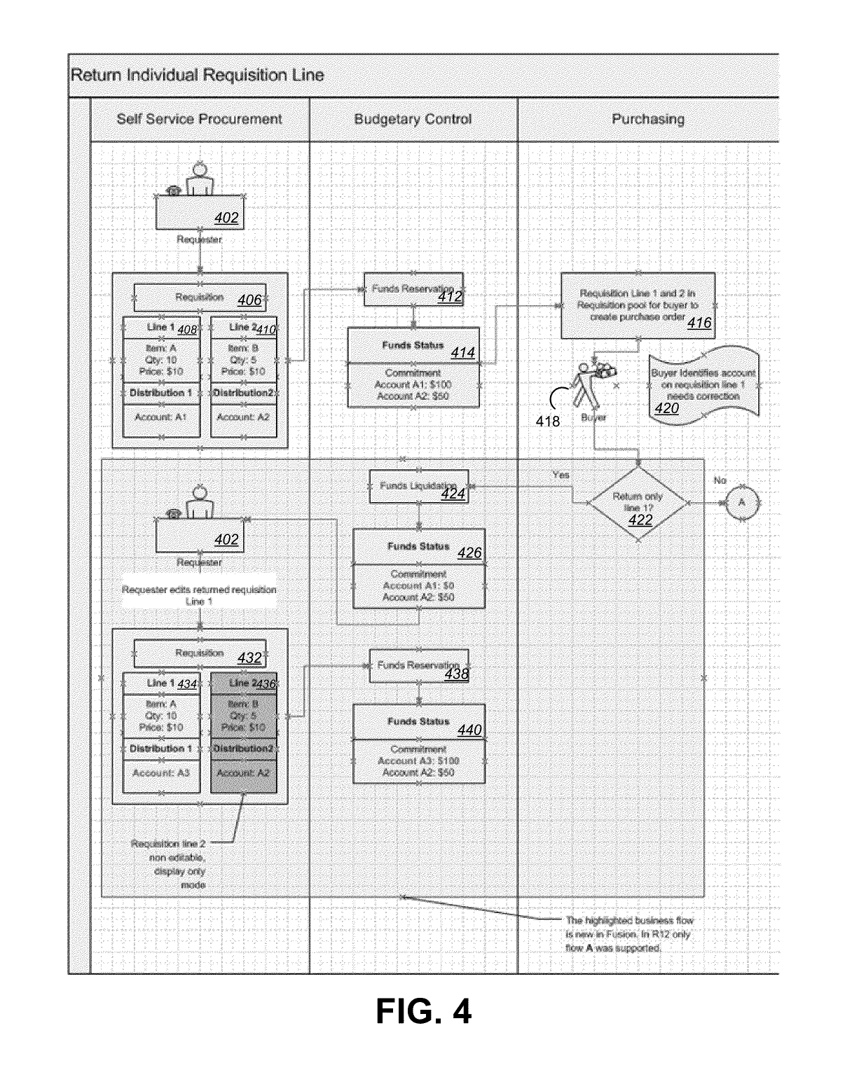

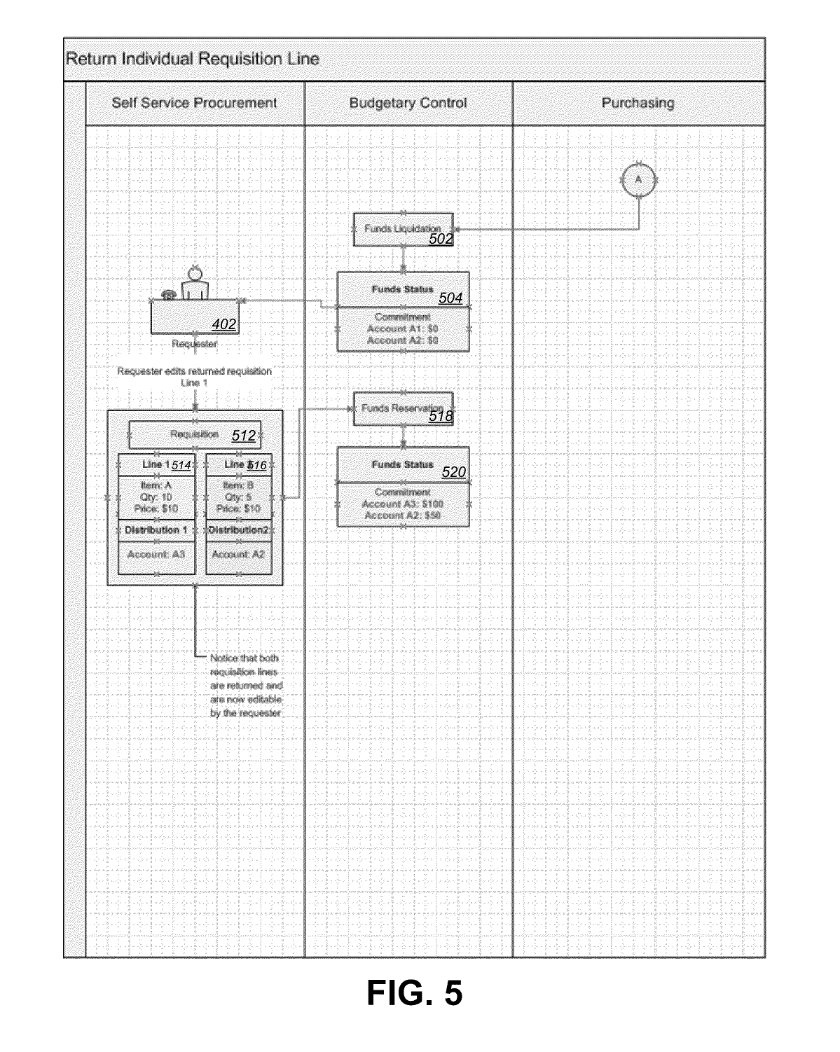

FIG. 4 is a flowchart illustrating a process for processing individually returned requisition lines of a purchase requisition according to one embodiment of the present invention. As illustrated in this example, the process can begin with a requestor 402 generating and submitting a requisition 406 having a plurality of lines 408 and 410. The requisition can be used by a budgetary control module or application to reserve funds 412 and update a status 414 for those funds. The requisition 406 can then be presented to a buyer 418 for generation 416 of a purchase order. However, the buyer 418 may determine 420 that one or more of the lines, e.g., line 1 408, of the requisition are incorrect and should be returned for correction. In this case, a further determination 422 can be made as to whether the entire requisition or only some portion/lines thereof should be returned. In response to determining 422 to return the entire requisition, processing can continue as illustrated in FIG. 5.

FIG. 5 is a flowchart illustrating additional details of a process for processing individually returned requisition lines of a purchase requisition according to an embodiment of the present invention. In this example, when returning an entire requisition, the funds previously reserved 412 for that requisition can be liquidated 502 and the status of those funds can be updated 504. The returned requisition 512 can then be presented to the requester 506 for correction. It should be noted that in this case, the entire returned requisition 512, including all lines 514 and 516 are presented to the requestor 402 and made available for editing. Once the returned requisition 512 has been updated or corrected by the requestor 402, the funds can again be reserved 518, the status of those funds can be updated 520, and the requisition can be resubmitted for approval.

Returning to FIG. 4, if a determination 422 is made to return less than all of the requisition, the determination 422 can also include determining which line or set of lines to return as well as possibly identifying additional related or relevant lines. These additional lines can be provided for information purposes but are not the subject of the return. Once the returned lines are identified, the funds for those lines can be liquidated 424 and a status of those funds can be updated 426. Note that the other requisition lines continue to be reserved and processed into purchase orders if necessary. The returned lines and any additional related lines of the requisition 432 can be presented to the requestor 402. For example, line 1 434 may be the subject of the return and can be made available to the requestor for editing. However, line 2 436 may be related or contain some information relevant to line 1 434. In this case, line 2 436 can also be presented but in a read-only mode. Once the returned requisition 432 has been updated or corrected by the requestor 402, the funds can again be reserved 438, the status of those funds can be updated 440, and the requisition can be resubmitted for approval.

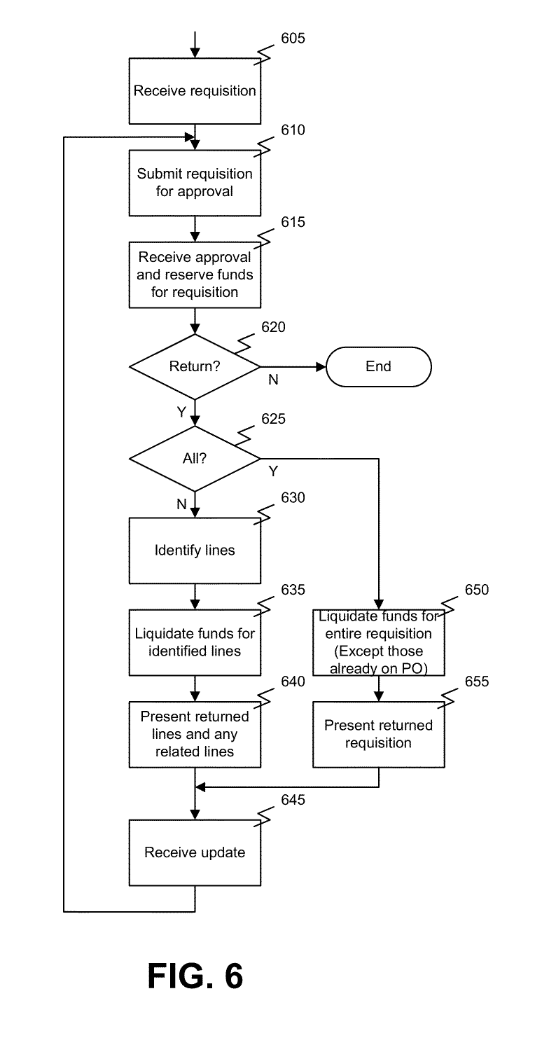

FIG. 6 is a flowchart illustrating a method for processing individually returned requisition lines of a purchase requisition according to one embodiment of the present invention. In this example, processing a purchase requisition in a procurement system can begin with receiving 605 from a requestor a requisition comprising a plurality of requisition lines. The requisition can be submitted 610 for approval and, upon approval, funds of a budget can be reserved 615 for each of the plurality of requisition lines of the requisition. A determination 620 can be made as to whether to return at least one line of the plurality of lines of the requisition prior to approval of the requisition. Determining 620 to return at least one line of the plurality of lines of the requisition can further comprise determining 625 whether to return all or less than all of the lines of the requisition.

In response to determining to return at least one but less than all of the lines of the requisition, the returned lines can be identified 630. One or more lines of the requisition related to the returned lines can also be identified 630. The reserved funds for the returned at least one line of the requisition can be liquidated 635 and the returned at least one line can be presented 640 to the requestor. Presenting 640 the returned at least one line of the requisition to the requestor can further comprise presenting the one or more lines of the requisition related to the returned at least one line. These related lines may be presented in a read-only mode. An update of the returned lines can be received 645. Funds of the budget can be reserved 610 for the returned at least one line based on the update of the returned lines and the update can be re-submitted 615 for approval.

Alternatively, in response to determining 625 to return all of the lines of the requisition prior to approval, the reserved funds for the entire requisition can be liquidated 650, possibly excluding those funds already on a purchase order, and all of the lines of the requisition can be presented 655 to the requestor. An update of the requisition can be received 645 from the user and funds of the budget can be reserved 610 for the requisition based on the update of the requisition. The entire updated requisition can then be re-submitted 615 for approval.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of processing a purchase requisition in a procurement system, the method comprising:
receiving, by the procurement system, from a requestor a first requisition comprising a plurality of requisition lines;
submitting, by the procurement system, the first requisition for approval;
reserving, by the procurement system, funds of a budget for each of the plurality of requisition lines of the first requisition;
determining, by the procurement system, to return at least one line of the plurality of lines of the first requisition prior to approval of the first requisition; and
liquidating, by the procurement system, the reserved funds for the returned at least one line of the first requisition without affecting the reserved funds for the plurality of requisition lines other than the returned at least one line.

2. The method of claim 1, further comprising:
presenting, by the procurement system, the returned at least one line of the first requisition to the requestor;
receiving, by the procurement system, an update of the returned at least one line of the first requisition;
reserving, by the procurement system, funds of the budget for the returned at least one line of the first requisition based on the update of the returned at least one line of the first requisition;
re-submitting, by the procurement system, the update of the returned at least one line of the first requisition for approval.

3. The method of claim 2, wherein determining to return the at least one line of the plurality of lines of the first requisition further comprises identifying one or more lines of the first requisition related to the returned at least one line.

4. The method of claim 3, wherein presenting the returned at least one line of the first requisition to the requestor further comprises presenting the one or more lines of the first requisition related to the returned at least one line.

5. The method of claim 4, wherein presenting the one or more lines of the first requisition related to the returned at least one line comprises presenting the one or more lines of the first requisition related to the returned at least one line in a read-only mode.

6. The method of claim 2, wherein the at least one line of the first requisition comprises less than all of the plurality of lines of the first requisition.

7. The method of claim 6, further comprising:
receiving, by the procurement system, from the requestor a second requisition comprising a plurality of requisition lines;
reserving, by the procurement system, funds of the budget for each of the plurality of requisition lines of the second requisition;
submitting, by the procurement system, the second requisition for approval;
determining, by the procurement system, to return all of the plurality of lines of the second requisition prior to approval of the second requisition;
liquidating, by the procurement system, the reserved funds for the second requisition;
presenting, by the procurement system, all of the lines of the second requisition to the requestor;
receiving an update of the second requisition from the user;
reserving, by the procurement system, funds of the budget for the second requisition based on the update of the second requisition;
re-submitting, by the procurement system, the updated second requisition for approval.

8. A system comprising:
a processor; and
a memory coupled with and readable by the processor and having stored therein a sequence of instructions which, when executed by the processor, cause the processor to process a purchase requisition by receiving from a requestor a first requisition comprising a plurality of requisition lines, submitting the first requisition for approval, reserving funds of a budget for each of the plurality of requisition lines of the first requisition, determining to return at least one line of the plurality of lines of the first requisition prior to approval of the first requisition, and liquidating the reserved funds for the returned at least one line of the first requisition without affecting the reserved funds for the plurality of requisition lines other than the returned at least one line.

9. The system of claim 8, wherein processing the purchase requisition further comprises:
presenting the returned at least one line of the first requisition to the requestor;
receiving an update of the returned at least one line of the first requisition;
reserving funds of the budget for the returned at least one line of the first requisition based on the update of the returned at least one line of the first requisition;
re-submitting the update of the returned at least one line of the first requisition for approval.

10. The system of claim 9, wherein determining to return the at least one line of the plurality of lines of the first requisition further comprises identifying one or more lines of the first requisition related to the returned at least one line.

11. The system of claim 10, wherein presenting the returned at least one line of the first requisition to the requestor further comprises presenting the one or more lines of the first requisition related to the returned at least one line.

12. The system of claim 11, wherein presenting the one or more lines of the first requisition related to the returned at least one line comprises presenting the one or more lines of the first requisition related to the returned at least one line in a read-only mode.

13. The system of claim 12, wherein processing the purchase requisition further comprises:
receiving from the requestor a second requisition comprising a plurality of requisition lines;
reserving funds of the budget for each of the plurality of requisition lines of the second requisition;
submitting the second requisition for approval;
determining to return all of the plurality of lines of the second requisition prior to approval of the second requisition;
liquidating the reserved funds for the second requisition;
presenting all of the lines of the second requisition to the requestor;
receiving an update of the second requisition from the user;
reserving funds of the budget for the second requisition based on the update of the second requisition;
re-submitting the updated second requisition for approval.

14. A computer-readable memory having stored thereon a sequence of instructions which, when executed by a processor, causes the processor to process a purchase requisition by:
receiving from a requestor a first requisition comprising a plurality of requisition lines;
submitting the first requisition for approval;
reserving funds of a budget for each of the plurality of requisition lines of the first requisition;
determining to return at least one line of the plurality of lines of the first requisition prior to approval of the first requisition; and
liquidating the reserved funds for the returned at least one line of the first requisition without affecting the reserved funds for the plurality of requisition lines other than the returned at least one line.

15. The computer-readable memory of claim 14, further comprising:
presenting the returned at least one line of the first requisition to the requestor;
receiving an update of the returned at least one line of the first requisition;
reserving funds of the budget for the returned at least one line of the first requisition based on the update of the returned at least one line of the first requisition;
re-submitting the update of the returned at least one line of the first requisition for approval.

16. The computer-readable memory of claim 15, wherein determining to return the at least one line of the plurality of lines of the first requisition further comprises identifying one or more lines of the first requisition related to the returned at least one line.

17. The computer-readable memory of claim 16, wherein presenting the returned at least one line of the first requisition to the requestor further comprises presenting the one or more lines of the first requisition related to the returned at least one line.

18. The computer-readable memory of claim 17, wherein presenting the one or more lines of the first requisition related to the returned at least one line comprises presenting the one or more lines of the first requisition related to the returned at least one line in a read-only mode.

19. The computer-readable memory of claim 18, further comprising:
receiving from the requestor a second requisition comprising a plurality of requisition lines;
reserving funds of the budget for each of the plurality of requisition lines of the second requisition;
submitting the second requisition for approval;
determining to return all of the plurality of lines of the second requisition prior to approval of the second requisition;
liquidating the reserved funds for the second requisition;
presenting all of the lines of the second requisition to the requestor;
receiving an update of the second requisition from the user;
reserving funds of the budget for the second requisition based on the update of the second requisition;
re-submitting the updated second requisition for approval.
